(19) United States
(12) Patent Application Publication
(10) Pub. No.: US 2014/0253085 A1
(43) Pub. Date: Sep. 11, 2014

(54) Digital programmable control systems

(71) Applicant: Chung Shan Institute of Science and Technology, Armaments Bureau, M.N.D, (US)

(72) Inventors: Chien-Min Kao, Taoyuan County (TW); Kuo-Kuang Jen, Taoyuan County (TW); Kuo-Sheng Fu, Taoyuan County (TW); Ying-Sun Huang, Taoyuan County (TW)

(73) Assignee: Chung Shan Institute of Science and Technology, Armaments Bureau, M.N.D, Taoyuan County (TW)

(21) Appl. No.: 13/793,351

(22) Filed: Mar. 11, 2013

(51) Int. Cl. G05F 5/00

(52) U.S. Cl. CPC G05F 5/00
USPC 323/299

(57) ABSTRACT

A digital programmable control system, which is composed of a micro control module receives a detection result by using a detection module to detect a voltage and a current on a battery module and a bus module, and a judgment program in the micro control module determines whether the detection result meets a switching condition, and generates a control signal to control a bidirectional conversion module to perform a switching procedure in order to achieve the purpose of high accuracy regulation voltage and current.

### BACKGROUND OF THE INVENTION

1. Field of the Invention

The present invention relates to a digital programmable control system, and more particularly, to a digital programmable control system, which applies a digital programmable control manner to adjust voltages and currents of the circuit.

2. Description of the Related Art

Common control modes of output constant voltage and output constant current are achieved by using digital resistors, such as MCP 4651, which contains the first variable resistance 11 in the constant voltage circuit and the second variable resistance 12 in the constant current circuit and both accuracy are 256 steps. Moreover, the resistance value is modified by the I2C communication interface in the IC feedback simple block comprising a current amplifier used to receive a switch signal, so circuit designs only need to confirm each level constant voltage and constant current corresponding to the resistance value. As shown in FIG. 1, if want to modify the value of constant voltage, only need to correct R10 (the first variable resistance 11) resistance value to change the reference voltage of constant voltage. If want to modify the value of constant current, correction R2 (the second variable resistance 12) resistance value to change the reference voltage of constant current in order to achieve the system specification. However, the conventional digital resistance is regulation circuit voltage value and current value which is difficult in the structure operation design; need to add analog circuit control and detection voltage, current value. The digital variable resistance adjustment way, which adjustable range is too small, regulation accuracy is not high, and the digital variable resistance is easy to wear, along with the environment and temperature change which causes the error of the digital variable resistance and then causes the output instability, voltage and current ripple value is too large.

For the reason that the conventional method and device could not effectively solve the mentioned problems, a need has arisen to propose a digital programmable control system which detects a voltage signal and a current signal of the power converter so as to return the processing device to perform the judgment and control in order to achieve high accuracy regulating voltage and current.

### SUMMARY OF THE INVENTION

An object of the present invention is to provide a digital programmable control system, and the micro control module receives detection results generated by using the detection module to respectively detect a voltage/current on an end of the battery module and the bus module, and to use a judgment produces to determine whether the detection results meet the switching conditions and thus generates the control signals to control the bidirectional conversion module to perform switch procedure, to achieve the purpose of the high-accuracy regulation voltage and current.

For achieving the object above, a digital programmable control system is disclosed according to one embodiment of the present invention. The digital programmable control system comprises: a battery module, providing a power supply procedure; a bus module, providing a charging procedure; a bidirectional conversion module, electrically connected to the battery module and the bus module, allowing the battery module and the bus module to perform a power regulation procedure; a detection module, respectively detecting a voltage/current on an end of the battery module and the bus module so as to generate a detection result; and a micro control module, electrically connected to the detection module, receiving detection result and comprising a judgment program which determines whether the detection result meets a switching condition so as to generate a control signal to control the bidirectional conversion module for performing a switch procedure.

### BRIEF DESCRIPTION OF THE DRAWINGS

The invention, as well as its many advantages, may be further understood by the following detailed description and drawings in which:

FIG. 1 illustrates an architecture schematically diagram of the conventional digital control system; and

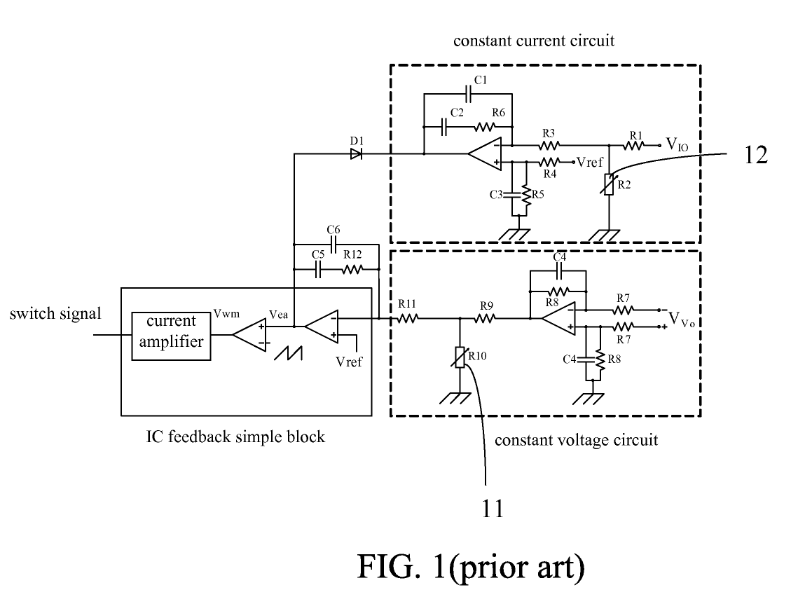

FIG. 2 illustrates an architecture diagram of the digital programmable control system of the present invention.

### DETAILED DESCRIPTION OF THE INVENTION

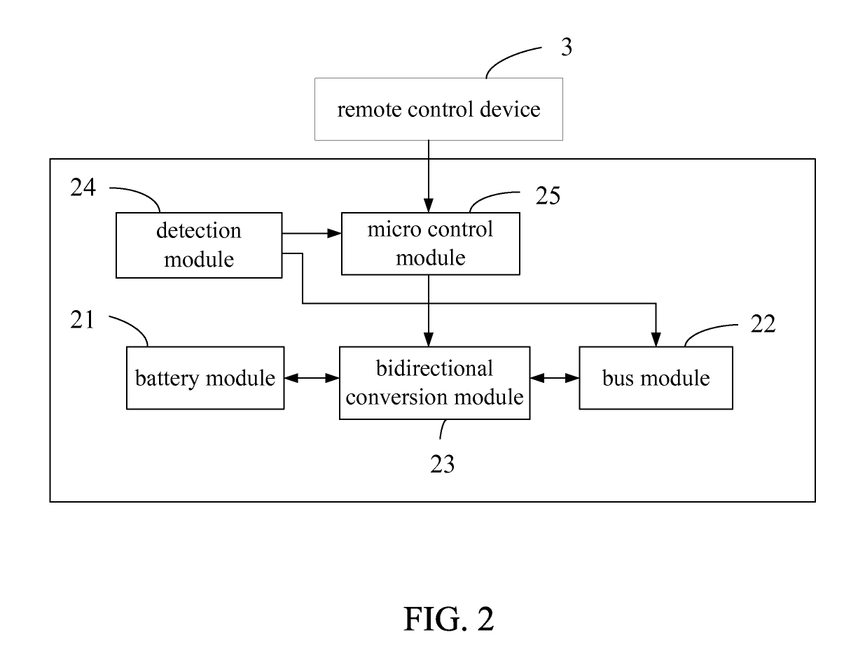

Referring to FIG. 2, which is the structure diagram of digital programmable control system of the present invention. As shown, the present invention contains a battery module 21, a bus module 22, a bidirectional conversion module 23, a detection module 24 and a micro control module 25.

The battery module 21 is used for performing a power supply procedure.

The bus module 22 is used for performing a charging procedure.

The bidirectional conversion module 23 is electrically connected to the battery module 21 and the bus module 22, and the bidirectional conversion module 23 allows the battery module 21 and the bus module 22 to perform a power regulation procedure.

The detection module 24 respectively detects a voltage/current on an end of the battery module and the bus module so as to generate a detection result;

The micro control module 25 which electric connecting with the detection module 24 and receiving the detection result, which is electrically connected to the detection module 24, receives the detection result and comprises a judgment program which determines whether the detection result meets a switching condition so as to generate a control signal to control the bidirectional conversion module 23 for performing a switch procedure.

The detection module 24 respectively detects the voltage/current on an end of the battery module 21, and detects the voltage/current on an end of the bus module 22. When the voltage/current on the end of battery module detected by the detection module 24 is larger than the bus module 22 so as to generate a first detection result, and the first detection result is transmitted to micro control module 25, and the judgment program determines whether the first detection result meets the switch condition to generate a first control signal to drive the bidirectional conversion module 23 to perform the switch procedure, and thereby, the battery module 21 performs the charging module to the bus module 22 for allowing the bus module 22 to transmit the power to the other modules that need the power.

When the detection module 24 detects the voltage on the end of the bus module 22 is lower than 360V, the battery module 21 will provide the power to the bus module 22 so as to perform the first step of the constant current charging. When the voltage on the end of the bus module 22 is greater than 360V, but smaller than 375V, and then performs the second step of the constant current charging. When the bus module 22 receives the power provided by the battery module 21 is greater than voltage value 375V, and perform the third step of the constant voltage charging so that the bus module 22 can transport the power provided by the battery module 21 to the other modules.

Furthermore, the detection module 24 detects the voltage/current on the end of the battery module 21 and the bus module 22. When the voltage/current on the end of the battery module 21 end is smaller than the voltage/current of the bus module 22 to generate a second detection result and then transport it to the micro module 25. The micro module 25 receives the second detection result, and the judgment program will determine whether the second detection result meets the switching conditions. When the judgment program based on the second detection result and determine that the voltage/current on the end of the battery module 21 is smaller than the voltage/current of the bus module 22 and then generate a second detection signal, which causes the bidirectional conversion module 23 to perform the switch procedure once more, so that the battery module 21 can receives the power which transports from the bus module 22 to perform the charging procedure, and the battery module 21 can receive the power which transported from the bus module 22 to perform charging.

The detection module 24 detects the bus module 22 end voltage which is greater than 390V, and the battery module 21 voltage is lower than the bus module 22 voltage, via judgment program, the micro control module 25 will determine whether the second detection result meets the switching conditions and then generate a second control signal to make the bidirectional conversion module 23 to perform the switch procedure. Therefore, it changes the charging direction from the battery module 21 to the bus module 22, to the charging direction from the bus module 22 to the battery module 21.

In this embodiment, the bidirectional conversion module 23 is a bidirectional full-bridge isolated DC/DC converter.

Further, the digital programmable control system of the present invention also allows users to use a remote control device 3 to perform a remote connection between the remote control device 3 and the digital programmable control system via a wire or wireless manner, and then users give instruction to control the micro control module 25 to generate a third control signal so as to regulate the bidirectional conversion module 23 to perform the switching procedure for adjust the power of the battery module 21 and the bus module 22.

Therefore, the micro control module 25 in the digital programmable control system receives detection results generated by using the detection module to respectively detect a voltage/current on an end of the battery module and the bus module, and to use a judgment produces to determine whether the detection results meet the switching conditions and thus generates the control signals to control the bidirectional conversion module to perform switch procedure, to achieve the purpose of the high-accuracy regulation voltage and current.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A digital programmable control system, comprising:
a battery module, providing a power supply procedure;
a bus module, providing a charging procedure;
a bidirectional conversion module, electrically connected to the battery module and the bus module, allowing the battery module and the bus module to perform a power regulation procedure;
a detection module, respectively detecting a voltage/current on an end of the battery module and the bus module so as to generate a detection result; and
a micro control module, electrically connected to the detection module, receiving detection result and comprising a judgment program which determines whether the detection result meets a switching condition so as to generate a control signal to control the bidirectional conversion module for performing a switch procedure.

2. The digital programmable control system of claim 1, wherein the detected voltage/current on the end of battery module is larger than the bus module so as to generate a first detection result, and the first detection result is transmitted to micro control module, and the judgment program determines whether the first detection result meets the switch condition to generate a first control signal to drive the bidirectional conversion module to perform the switch procedure, and thereby, the battery module performs the charging module to the bus module.

3. The digital programmable control system of claim 1, wherein the detected voltage/current on the end of battery module is smaller than the bus module so as to generate a second detection result, and the second detection result is transmitted to micro control module, and the judgment program determines whether the second detection result meets the switch condition to generate a second control signal to drive the bidirectional conversion module to perform the switch procedure, and thereby, the bus module performs the charging module to the battery module.

4. The digital programmable control system of claim 1, wherein the bidirectional conversion module is a bidirectional full-bridge isolated DC/DC converter
